(19) United States
(12) Patent Application Publication
(10) Pub. No.: US 2018/0066759 A1
(43) Pub. Date: Mar. 8, 2018

(54) VALVES

(71) Applicant: Northern Diver (International) Ltd, Wigan (GB)

(72) Inventor: Paul Case, Wigan (GB)

(73) Assignee: Northern Diver (International) Ltd, Wigan (GB)

(21) Appl. No.: 15/697,501

(22) Filed: Sep. 7, 2017

Related U.S. Application Data
(60) Provisional application No. 62/384,246, filed on Sep. 7, 2016.

(30) Foreign Application Priority Data
Sep. 7, 2016 (GB) 1615211.8

(51) Int. Cl. F16K 11/07; F16K 31/54; F16K 27/04

(52) U.S. Cl. CPC F16K 11/07; F16K 27/041; F16K 31/54

(57) ABSTRACT

A valve (50), which is particularly suitable for SCUBA apparatus, comprises a main body (52) with a sliding plug (58) in a bore (54) of the main body (52). The valve (50) has first (60) and second ports (62) in fluid communication with the bore (54). The plug (58) has first (64), second (66) and third plug portions (68). A set of seals (76, 78, 82) between the plug (58) and bore (54) separate the plug portions (76, 78, 82) from one another. The third plug portion (68), which is interposed between, and which has a smaller cross-sectional area than, the first (64) or second (66) plug portions, forms a fluid passageway (70) between the plug (58) and the bore (54) of the main body (52). The valve (50) comprises a rack (88) and pinion (90) for axially displacing the plug (58) by rotation of the pinion (90), such that the fluid passageway (70) can be moved so as to align with any one or more ports (60, 62). Further ports (94) and plug positions are also possible, and a valve position indicator (124) may be provided.

This invention relates to valves, and in particular, but without limitation, to valves suitable for use in SCUBA diving applications.

Valves, generally, are extremely well known, and are used to control the flow of fluids in pneumatic/hydraulic systems. Valves can be used to control the flow rate of a fluid, being either on/off valves, or flow rate controllers having various intermediate positons between “on” and “off”; and/or as diverters, namely to divert the flow of fluids between different ports of a valve.

Various valve configurations are already well-known, and these include rising stem type valves, rotary valves, vane valves and the like.

In order to operate correctly, valves must generally contain sealing elements, such as O-ring seals, gaskets, finely machined ceramic discs etc., which seat against various internal surfaces of the valve body to form a seal. Due to the nature of valves, these seals muse generally be dynamic, that is to say, capable of movement relative to the valve body, whilst still maintaining an adequate seal over extended duty cycles. O-ring seals, whilst often used in dynamic seals, often suffer from premature failure because they have a tendency to “roll” as the valve parts are moved relative to one another. In certain case, the O-ring seals can roll out of position causing the respective valve seal to be compromised, or can become trapped between relatively moving parts, thus pinching, tearing or otherwise damaging the O-ring. In many applications, regular replacement of O-ring seals is an acceptable compromise for the convenience of using O-rings, which are ubiquitous and inexpensive, but in mission-critical applications, such as in breathing air supply applications, this is not acceptable.

Further, the actuation of valves can be either manual, for example, using a handle, lever or knob; or automatic, using, for example, solenoids, motors etc. The extent of relative movement of the valve parts is generally proportional to the extent of movement of the actuator (lever, knob etc.) and where gross valve part movements are required, correspondingly gross movements of the actuator are required also. This can be problematic, especially where rapid switching of the valve is needed, and so it is desirable, in certain applications, to provide a mechanism for increasing the valve part movement relative to the actuator movement, which can introduce unwanted valve complexity and cost. Furthermore, adding mechanical components to a valve generally adds weight and increases the size of the valve, which is often undesirable.

All known valves have various advantages and disadvantages in different applications. However, as indicated above, there still exist some problems with known valves, in certain specific applications, which this invention aims to address and/or overcome. This invention therefore relates to a new and alternative type of valve, and/or a new/alternative type of valve, addresses or overcomes one or more of the shortcomings indicated above.

As mentioned above, one target application for this invention subsists in the field of respirators, and in particular, to underwater breathing apparatus. SCUBA diving is an inherently hazardous activity because the diver is reliant on a supply of breathable air from a cylinder, which is delivered to his/her mouthpiece via an air hose. If the air supply runs out, for example, due to a leak developing in his/her SCUBA apparatus, then the consequences can be extremely dangerous. Equally, a failure of any part of a diver's SCUBA apparatus during a dive can prove fatal.

Accordingly, it is standard operating procedure, for SCUBA divers to carry with them at all times, a reserve air supply, which can be used in the event of his/her primary air supply failing or running out.

Historically, reserve air supplies were completely separate systems, which offered 100% redundancy (i.e. a separate cylinder, air hose, regulator and mouthpiece), but these systems tended to be bulky and inconvenient. Also, compete duplication of a diver's SCUBA apparatus tends to restrict his/her movements underwater, as well as adding weight to his/her equipment, which is generally undesirable. Furthermore, in modern full-face mask SCUBA setups, it is not possible to substitute one mouthpiece for another without also removing the diver's mask, which, underwater, is highly undesirable.

Nowadays, in order to address these shortcomings, a SCUBA diver's breathing apparatus comprises a primary and a reserve air supply cylinder, but only a single regulator and mask/mouthpiece. This necessitates the use of a diverter valve to enable the diver to switch between the primary and reserve air cylinders. The diverter valve is therefore a critical piece of equipment, which cannot fail, and is thus robustly constructed and uses planar gaskets to avoid problems with O-ring seal failures. Due to its robust construction, the known diverter valve is a heavy and bulky item of equipment, and is thus worn on the diver's chest/abdomen, held in place using a harness. The diver can therefore access the valve relatively easily because is it within easy reach, but the diver's movements can be restricted, especially bending forwards at the waist, due to the presence of the diverter valve.

A further problem with this known arrangement is the presence of an additional air hose. Specifically, the primary and reserve air cylinders connect to respective inlet ports of the valve using separate air hoses, and a further air hose connects the diverter valve's outlet to the diver's regulator. Clearly, each additional connection and hose introduces a finite risk of failure and so it is desirable to rationalise the part count of the SCUBA apparatus as much as possible.

One proposal has been to connect to the valve's outlet directly to the regulator, but given the size and bulk of the known diverter valve, this is impractical as it restricts the diver's field of view, and also is too heavy, in practice, to suspend from the mask.

A need therefore exists for an improved/alternative type of valve, and one which addresses or overcomes one or more of the above problems.

According to the invention, there is provided A valve comprising: a main body comprising: a bore having an axis, a first port in fluid communication with the bore and a second port in fluid communication with the bore, a plug slidingly receivable within the bore comprising: a first plug portion slidingly receivable within the bore; a second plug portion slidingly receivable within the bore; and a third plug portion interposed between the first and second plug portions, the third plug portion having a smaller cross-sectional area than the first or second plug portions, and forming, when inserted in the bore, a fluid passageway between an exterior surface of the third plug portion and an interior surface of the bore, first and second axially spaced-apart seals forming respective seals between the exterior surface of the first plug portion and the interior surface of the bore; a third seal forming a seal between the exterior surface of the second plug portion and the interior surface of the bore, wherein: the first and second ports are axially offset such that: when the plug is in a first position, the first port is located at a position between the first and second seals, and the second port is located a position between the second and third seals; but when the plug is in a second position, the first and second ports are located at a position between the second and third seals; wherein the valve further comprises: a rack operatively connected to the plug, and a pinion gear arranged to mesh with the rack, whereby rotation of the pinion gear causes the plug to move between the first and second positions.

The valve is thus actuated via a rack-and-pinion arrangement such that rotation of the pinion causes the plug to move axially within the bore between the first and second positions. Suitably, the rack-and-pinion arrangement is utilised to reduce the amount of input movement required to actuate the valve. Suitably, therefore, the gearing is selected such that rotation of the pinion gear through substantially ninety degrees causes the plug to move between the first and second positions. A knob may be used to actuate the pinion gear either directly or indirectly.

In other words, the invention subsists in a valve that is actuated using a rack-and-pinion arrangement, which when so actuated, axially displaces the annular-prismatic fluid passageway of the plug such that the fluid passageway selectively aligns with, or misses, selected ones, or groups, of ports.

In an embodiment of the invention, the valve comprises an on/off type valve.

Suitably, when the when the plug is in the second position, the valve is “open” or “on”, that is to say, the fluid passageway interconnects the first and second ports. When the valve is in the second position, the second and third seals cooperate with the fluid passageway to prevent leakage of fluid passing through the valve.

Conversely, when the plug is in the first position, the valve is “closed” or “off”, that is to say, the second seal separates the first port from the second port. Notably, when in the valve is in the first position, the first and second seals are axially disposed to either side of the first port, thus closing it off, and the second and third ports are axially disposed to either side of the second port, thus closing it off also. Therefore, when in the first position, both the first and second ports are isolated.

The first port can comprise an inlet and the second port comprises an outlet, or vice-versa. This usefully enables fluid to flow in either direction through the valve.

In other embodiments of the invention, the valve comprises a diverter valve. In such embodiments, the main body may comprise a third port in fluid communication with the bore; the second plug portion may comprise a fourth seal forming a seal between the exterior surface of the second plug portion and the interior surface of the bore; and the first, second and third ports are suitably axially offset relative to one another such that: when the plug is in the first position, the first port is located at a position between the first and second seals, and the second and third ports are located at positions between the second and third seals; but when the plug is in the second position, the first and second ports are located at a position between the second and third seals, and the third port is located at a position between the third and fourth seals.

In the diverter valve embodiment of the invention, when the plug is in the first position, the fluid passageway interconnects the second and third ports, but when the valve in the second position, the fluid passageway interconnects the first and second ports.

Any utile inlet/outlet configuration may be used. For example, the first and third ports may be inlets and the second port may be an outlet. In this configuration, when the plug is in the first position, the valve interconnects the third and second ports, and isolates the first port, whereas when in the second position, the first and second ports are interconnected and the third port is isolated.

In another example, the first and third ports may be outlets and the second port may be an inlet. In this configuration, when the plug is in the first position, the valve interconnects the second and third, and isolates the first port, whereas when in the second position, the second and first ports are interconnected and the third port is isolated.

In order to increase the reliability of the valve, the plug suitably comprises a respective radial groove for receiving and/or retaining each of the said seals, which are suitably O-ring seals. Ideally, the radial grooves are arranged perpendicular to the direction of movement of the plug, that is to say, their planes are suitably arranged perpendicularly to the axis of the bore. Such a configuration causes the O-ring seals to slide as they are designed to do relative to the bore, rather than to roll. The invention sees the internal fluid passageway of the valve being formed by the third plug portion having a smaller cross-sectional area than the first or second plug portions (i.e. a waist portion) that and suitably forms an annular-prism-shaped fluid passageway between an exterior surface of the third plug portion and an interior surface of the bore. This configuration is distinct from known sliding or rotating plug valve arrangements, in which there is a through bore in the plug, which has a “hit-or-miss” relationship with the ports. In the known type of “through bore plug” valves, the O-ring seals surround the ports (i.e. they lie in a plane that is parallel to the movement of the plug, and this can give rise to rolling of the O-rings out of position. However, as the movement of the plug in the present invention is axial, and because the seals are formed circumferentially around the first and second plug portions and the interior surface of the main body, sliding of the plug relative to the main body is far less likely to cause premature failure of the O-ring seals.

The ports can be in-line, or they can be radially offset relative to one another. Radially offsetting the outlet at ninety degrees to the inlet or inlets is useful in certain applications, such as in SCUBA applications where the valve may usefully be used to incorporate a right-angled bend, so as to enable the connection of pipes etc. at more convenient angles.

Suitably, means is provided for indicating the position of the plug, i.e. the state of the valve. This can be accomplished “mechanically”, for example by the plug comprising an axial extension that is arranged to protrude through an aperture of the main body when the plug is in one of the first and second positions, but which retracts into the main body when the plug is in the other of the first and second positons. Additionally or alternatively, the means for indicating that state of the valve can be electronic, for example, comprising a magnetic reed switch disposed within the plug, a magnet disposed with in the main body, a circuit and an indicator light. In such a configuration, the reed switch can be used so sense the position of the plug, and hence the state of the valve. Suitably, therefore, the circuit is adapted to illuminate the indicator light when the reed switch is in a first position relative to the magnet, and to extinguish the indicator light when the reed switch is in a second position relative to the magnet. This may be a particularly beneficial feature of a SCUBA diving valve, where the user and/or onlookers may need to be able to ascertain quickly the status of the valve. As such, the circuit may comprise a battery and an LED, which is suitably a high-intensity, wide-angle, red-coloured LED. Further, the circuit may be adapted to illuminate the indicator light intermittently when the reed switch is in the first position relative to the magnet. In SCUBA applications, this is particularly beneficial because, if, say, a diver switches to his/her reserve air supply (by actuating his/her diverter valve), this can be indicated to the diver, as well as his/her diving “buddy” by way of a bright-red, flashing LED. In order to be useful in diving applications, the means for indicating is suitably waterproof.

A preferred embodiment of the invention sees the valve used as a SCUBA diving diverter valve, in which the first port is an inlet operatively connectable to a primary air hose, the third port is an inlet port operatively connectable to a reserve air hose, and wherein the second port is an outlet port operatively connectable, in use, to a regulator. Suitably, the second port is directly connectable, in use, to the regulator, such that a third air hose between the valve's outlet and the regulator is redundant. In the case of a SCUBA diving diverter valve, the primary air hose interconnects, in use, the first port to a primary breathable air cylinder, and the reserve air hose interconnects, in use, the third port to a reserve breathable air cylinder.

The diverter valve of the invention may be particularly suited to use in mission-critical applications due to increased reliability, as explained in herein.

Due to the construction of the valve, it can be much smaller and lighter than known valves.

One of the advantages of the invention is that the O-rings are arranged to slide within the hollow interior part of the main body portion, and this reduces the likelihood of O-ring failure because they are designed to slide against a cylindrical surface, and not to roll as is the case with existing diverter valves. A further advantage of the invention is the fact that, due to its simplicity, it can be made much more compact than the existing diverter valves used in underwater breathing apparatus applications, and this enables it to be fitted directly to the regulator/mouthpiece, rather than having to be worn on a chest plate. This obviates the need for an additional umbilical tube leading from the regulator valve to the face piece, thereby rationalising equipment that a diver needs to carry and also reducing the likelihood of failure because the part count has been reduced as well.

Suitably, the main body is unitary, that is to say, comprising integrally-formed inlet and outlet spigots. In known SCUBA valves, the air hoses connect to the valve via double-ended screw-threaded connectors, that screw into the valve and onto the air hoses. However, by integrating the inlet/outlet spigots into the main body, it reduces the number of O-ring seals that are required, thereby reducing the likelihood of premature failure and/or inadvertent disconnection of one of the breathing tubes from the device.

Whilst the invention has been described in a SCUBA diving context, it is not limited to such applications.

Embodiments of the invention shall now be described, by way of example only, with reference to the accompanying drawings in which:

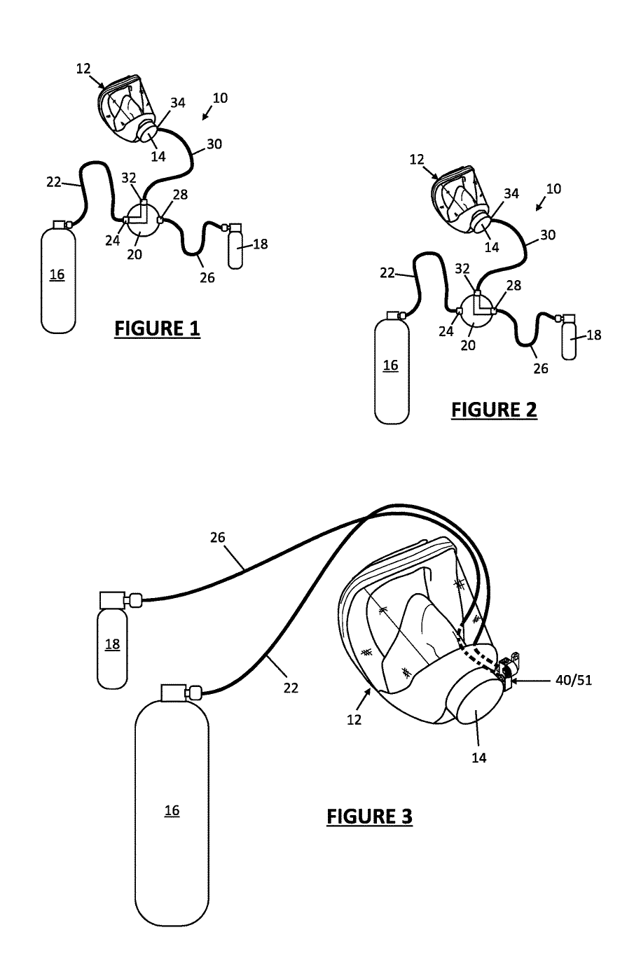

FIGS. 1 and 2 are simplified, schematic diagrams of a known SCUBA diving apparatus incorporating a diverter valve;

FIG. 3 is a simplified schematic diagram of a SCUBA diving apparatus incorporating a diverter valve in accordance with an embodiment of the invention;

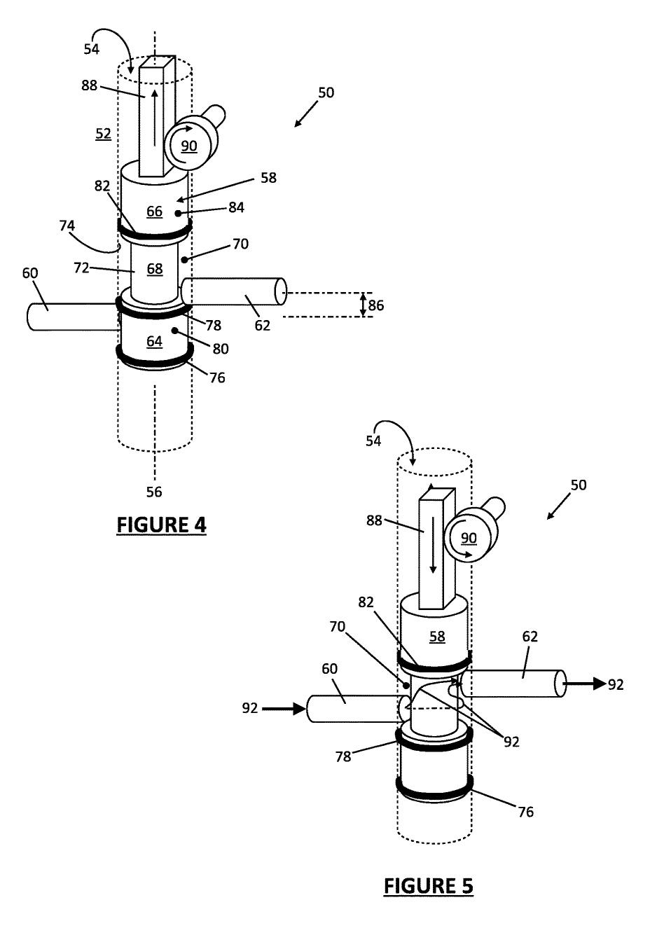

FIGS. 4 and 5 are schematic views showing the internal configuration of an on/off valve embodiment of a valve in accordance with the invention in the invention;

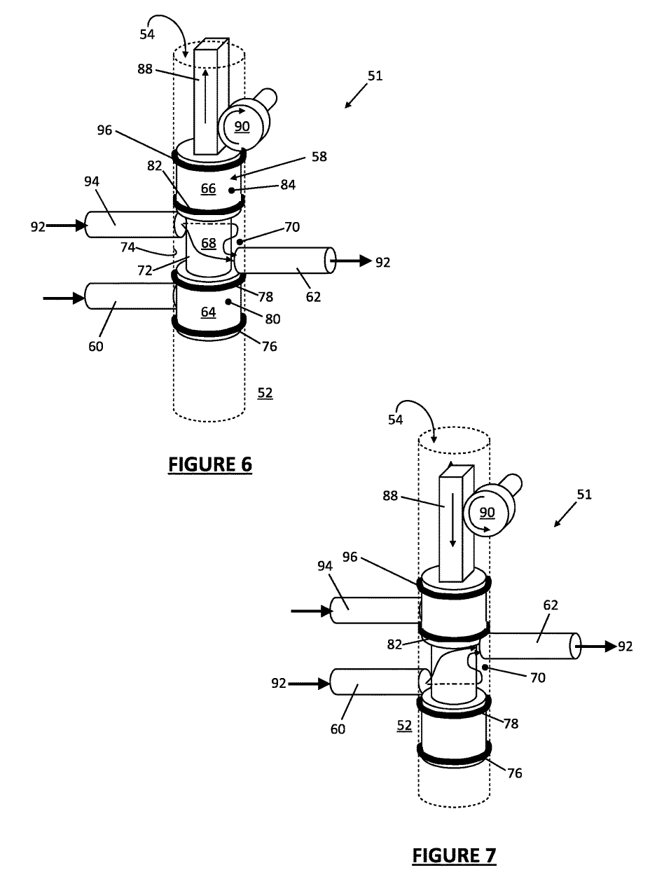

FIGS. 6 and 7 are schematic views showing the internal configuration of a diverter valve embodiment of a valve in accordance with the invention in the invention;

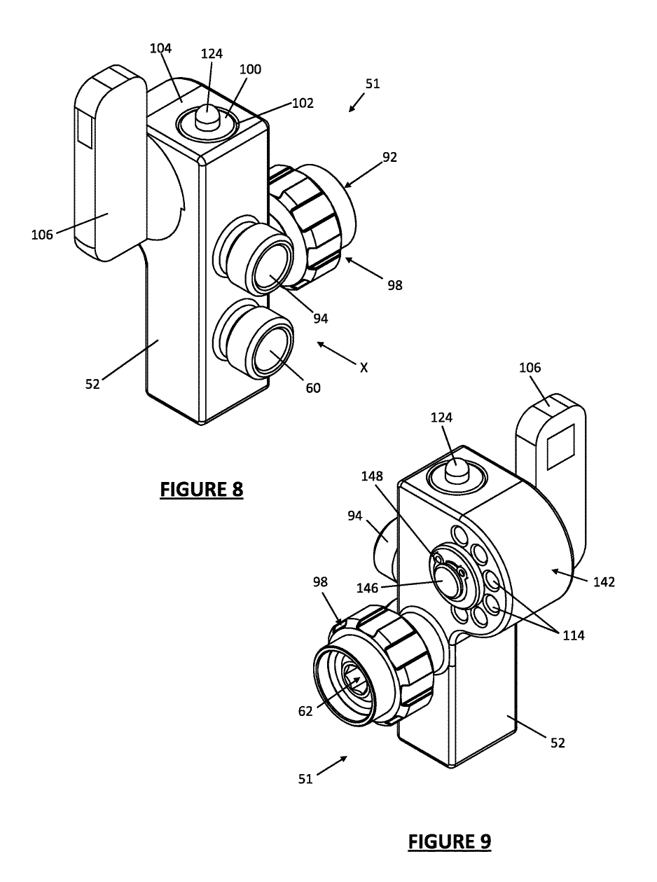

FIGS. 8 and 9 are perspective views of a diverter valve embodiment of the invention;

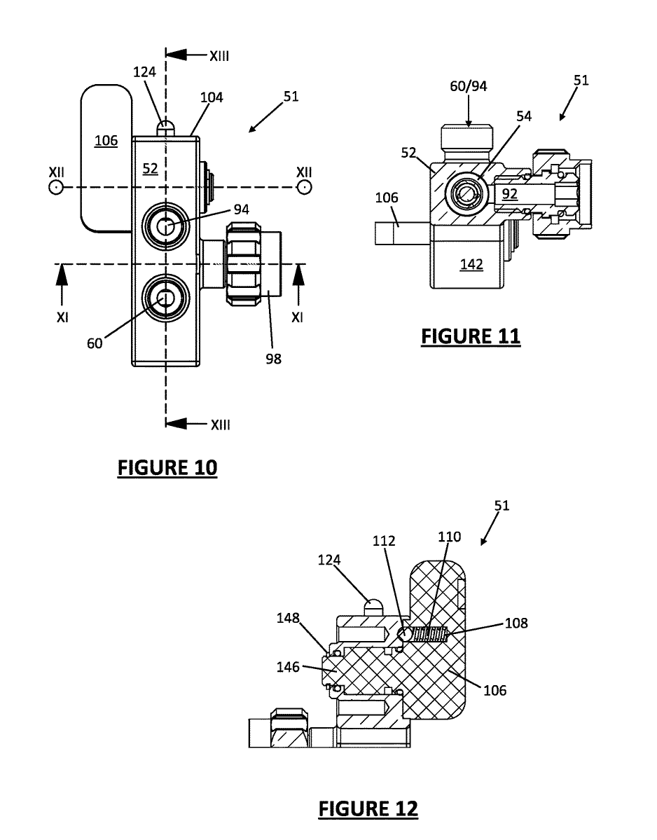

FIG. 10 is a side view of FIG. 8 viewed along direction X of FIG. 8;

FIG. 11 is a sectional view of the diverter valve of FIGS. 8 and 9, along XI-XI of FIG. 10;

FIG. 12 is a sectional view of the diverter valve of FIGS. 8 and 9, along XII-XII of FIG. 10; and

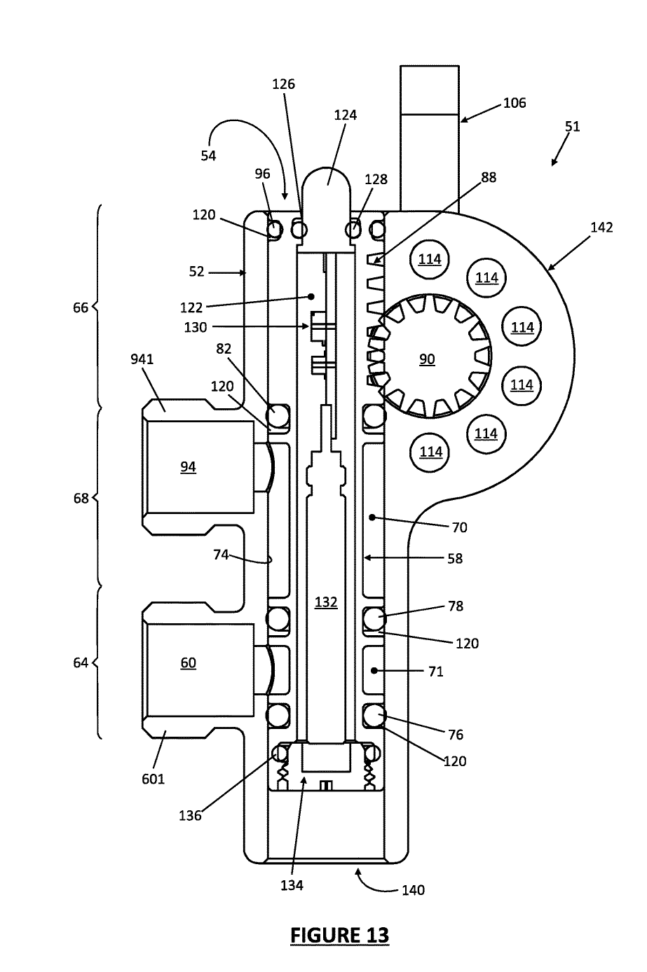

FIG. 13 is a sectional view of the diverter valve of FIGS. 8 and 9, along XIII-XIII of FIG. 10.

Referring to FIGS. 1 and 2 of the drawings, a known SCUBA diving apparatus 10 comprises face mask 12 having an integral breathing regulator 14. The regulator 14 connects to either a primary air supply cylinder 16, or to a reserve air supply cylinder 18 via diverter valve 20. A primary air hose 22 connects the primary air supply cylinder 16 to a first inlet 24 of the diverter valve 20, and a secondary air hose 26 connects the reserve air supply cylinder 18 to a second inlet 28 of the diverter valve 20. An umbilical air hose 30 connects an outlet 32 of the diverter valve 20 to an inlet 34 of the regulator 14. A diver (not shown) can breathe air from the primary air cylinder 16 when the diverter valve 20 is in the first position, as shown in FIG. 1, or he/she can switch to breathing from the reserve air cylinder 18 by moving the diverter valve position as shown in FIG. 2. The known arrangement of FIGS. 1 and 2 has a chest-mounted diverter valve 20, and three air hoses, each with respective connections at either end.

Referring to FIG. 3 of the drawings now, a simplified arrangement is provided by an embodiment of the invention. Identical features to those described previously have been called-out using identical reference signs, to avoid repetition herein. In FIG. 3, the diverter valve 40 is much more compact, and has an outlet that can be connected directly to the regulator 14. This configuration obviates the need for the umbilical air hose 30, and reduces the number of connections required. Thus, the SCUBA apparatus has been rationalised and rendered inherently more reliable by reducing the number of potential failure points. Also, by moving the diverter valve 40 to the side of the face mask 12, the diver (not shown) no longer needs to wear a chest harness to carry the known diverter valve 20.

Referring to FIGS. 4 and 5, an embodiment of a valve 50 in accordance with the invention comprises a main body 52 formed, for example, from a block of stainless steel. The main body has a bore 54 machined into it (along a bore axis 56), which forms a cylindrical cavity for slidingly receiving a plug 58. The valve 50 has a first port 60, which is in fluid communication with the bore 54 and a second port 62, also in fluid communication with the bore 54.

The plug 58 is a unitary component, but has three main parts, namely, a lower (in the illustrated embodiment) first plug portion 64, an upper (in the illustrated embodiment) second plug portion 66; and a third plug portion 68 interposed between the first 64 and second 66 plug portions. The third plug portion 68 has a smaller cross-sectional area than the first 64 or second 66 plug portions, and this is accomplished by turning down a narrower “waist” portion in the plug 58 in the region of the third plug portion 68.

This configuration forms, when the plug 58 is inserted in the bore 54, a fluid passageway 70 between an exterior surface 72 of the third plug portion 68 and an interior surface 74 of the bore 54.

The valve 50 has first 76 and second 78 axially spaced-apart seals forming respective seals between the exterior surface 80 of the first plug portion 64 and the interior surface 74 of the bore 54. The valve 50 also has a third seal 82 forming a seal between the exterior surface 84 of the second plug portion 66 and the interior surface 74 of the bore 54.

It will be noted in FIGS. 4 and 5 that the first 60 and second 62 ports are axially offset 86 such that when the plug 58 is in a first position (as shown in FIG. 4), the first port 60 is located at a position between the first 76 and second 78 seals, and such the second port 62 is located a position between the second 78 and third 82 seals. In this position, the valve is in an “off” position because the inlet 60 is closed-off by the first 76 and second 78 seals, and the second port 62 is also closed-off by the second 78 and third 82 seals. The first 60 and second 62 ports are effectively isolated from one another by the second seal 78.

As can be seen, the valve 50 further comprises a rack 88 formed as an extension of the plug 58, and this has teeth (not shown), which engage with the teeth (not shown) of a pinion gear 90. Rotation of the pinion gear 90 causes the plug 58 to move between a first position (as shown in FIG. 4) and a second position (as shown in FIG. 5).

Thus, when the plug 58 is moved to the second positon (as shown in FIG. 4), both the first 60 and second 62 ports are located between the second 78 and third 82 seals. When in this position, the valve 50 is “on”, because fluid can flow in via the first port 60, through the fluid passageway 70 (as shown by arrows 92) and out via the second port 62, or vice-versa.

Turning now to FIGS. 6 and 7 of the drawings, a diverter valve embodiment of a valve 51 in accordance with the invention is substantially as described above in relation to FIGS. 4 and 5, but with the addition of a third port 94 and a fourth seal 96. Here, the third port 94 is also in fluid communication with the bore 54 and the fourth seal 96 forms a seal between the exterior surface 84 of the second plug portion 66 and the interior surface 74 of the bore 54.

As can be seen, the first 60, second 62 and third 94 ports are axially offset relative to one another such that when the plug is in the first position (as shown in FIG. 6), the first port 60 is located at a position between the first 76 and second 78 seals, and the second 62 and third ports 94 are located at positions between the second 78 and third 82 seals. Thus, fluid can flow between the third port 94 and the second port 62 (or vice-versa) when the valve 51 is in the first position.

However, when the pinion 90 is rotated so as to move the plug 58 to the second position (as shown in FIG. 7), the first 60 and second 62 ports are located at a position between the second 78 and third 82 seals, whereas the third port 94 is now located at a position between the third 82 and fourth 96 seals. Thus, fluid can flow now between the first port 60 and the second port 62 (or vice-versa) when the valve 51 is in the second position. The valve, can, of course, be reverted to the first state upon reverse-rotation of the pinion 90.

Turning now to an actual embodiment of a diverter valve 51 in accordance with the invention, as shown in FIGS. 8 to 13 of the drawings, in which identical features to those described previously have been called-out using identical reference signs, to avoid repetition herein below:

The diverter valve 51 has a main body 52 formed from a forged, then machined, single block of stainless steel. The main body 52 has a pair of integrally formed inlet spigots 60, 94, to which can be connected, in use (but not shown) primary 22 and reserve 26 air hoses respectively. The main body also has an integrally formed outlet spigot (not visible) to which is affixed a screw-fitting for connecting the outlet 62 directly to the inlet of a regulator 14.

The plug 58 has an integrally formed extension 100, which, when the valve 51 is set to the first position, as shown in FIGS. 8 to 14, i.e. with the reserve air supply 18 connected to the regulator 14, the extension is visible through an aperture 102 in the top face 104 of the main body 52. The pinion gear 90 is connected to a knob 106, which is accessible to a user from the outside of the main body 52.

As can be seen in FIG. 12 of the drawings in particular, the knob 106 has an internal blind hole 108, which carries a spring 110, which urges a ball bearing 112 into engagement with one of several apertures 114 in the main body. The ball bearing 114, spring 110 and apertures 114 together from a detent, which enables the knob 106 to be positively clicked into one of several possible positions, in this case, the first and second positions. This reduces the likelihood if inadvertent switching of the valve 51 position.

Referring to FIG. 13 of the drawings now, which is a cross-section of FIG. 10 on XIII-XIII, it can be seen that the main body 52 is formed as a unitary component, in this embodiment, by forging or casting the rough shape of the main body 52, and then subsequent machining/drilling operations. In particular, the bore 54 is formed by drilling a through aperture vertically (in FIG. 13) through the main body, to form a cylindrical cavity for receiving the plug 58. The plug 58 has a generally cylindrical form, such that is it slidingly receivable within the bore 54.

The outer surface of the plug 58 has been turned-down in a central portion to form the third plug portion 68, i.e. having a narrower external diameter than the majority of the remainder of the plug 58. When the plug 58 is inserted in the bore 54, it can be seen that the narrow portion of the plug 58 forming the third portion 68, an annular prismatic cavity 70 is thus formed, which provides the fluid passageway for the flow of fluids through the valve 51.

The first 64 and third 66 plug portions are respectively located below and above (in FIG. 13) the third plug portion, as previously described. In the illustrated embodiment, the first plug portion 64 is also turned-down to form a second annular prismatic cavity 71 between the interior surface 74 of the bore 54 and the first plug portion 64.

Channels 120 for receiving the first, 76, second 78, third 82 and fourth 96 O-ring seals are turned-down into the plug 58, and so the O-ring seals 76, 78, 82, 96 are seated against the interior surface 74 of the bore 54. Sliding of the plug 58 relative to the bore 54 is thus possible, whilst maintaining a reliable seal.

The plug 58 also has an axial through bore 122, which receives an indicator circuit comprising a high-intensity, red LED 124, which protrudes through an aperture 126 in the top of the plug 58. A seal is formed between the LED 124 and the aperture 126 using an O-ring seal 128. The indicator circuit also comprises a slender PCB 130, which fits inside the bore 122 of the plug 58, the PCB 130 has a position sensor, such as a magnetic reed switch, a mechanical micro-switch etc. (not visible), which detects the positon of the valve 51 as previously described. The indicator circuit also comprises a battery 132, which is also encapsulated within the bore 122 of the plug 58. An end cap 134 sealingly (by way of a further O-ring seal 136) and screw-threadedly closes-off the lower end of the bore 122, thus sealingly enclosing the indicator. The end cap 134 has a tool-engagement feature (such as a screwdriver slot) 138, which is accessible via the open bottom end 140 of the main body's bore 54, so that the end cap 134 can be unscrewed, and replaced, at intervals, for example for servicing, battery replacement etc. of the indicator.

An ear portion 142 is formed integrally with the main body 52, and this has a through bore for receiving an axle 146 for the pinion gear 90, which is held in-situ using a circlip 148 (as can be seen in FIG. 9). The detent-receiving apertures 114 previously described are also drilled-through the ear portion 142 and also serve as lightening holes. The rack 88, which engages the pinion gear 90 is machined into the outer surface of the second plug portion 66.

The two inlets 60, 94 are formed as through holes in spigots 601, 941 that are formed integrally with the main body 52 of the valve 51. An integrally-formed outlet spigot (not visible in FIG. 13) is also provided, which extends out from the main body 52 at ninety-degrees to the inlet spigots 601, 941.

The invention is not necessarily restricted to the details of the foregoing embodiments, which are merely exemplary of embodiments of the invention. For example, any materials, manufacturing methods, dimensions and uses (whether explicit or implicit) are exemplary of the embodiments described herein, and are not necessarily restrictive of the scope of this disclosure, which is determined by the appended claims. Further, any references to orientation (e.g., upper, lower, vertical, horizontal, etc.) are intended to help describe the invention with reference to the drawings, but it will be appreciated that the invention could be used in any orientation and that such references to orientations used herein are merely a convenient shorthand.

1. A valve comprising:
a main body comprising:
a bore having an axis,
a first port in fluid communication with the bore and
a second port in fluid communication with the bore,
a plug slidingly receivable within the bore comprising:
a first plug portion slidingly receivable within the bore;
a second plug portion slidingly receivable within the bore; and
a third plug portion interposed between the first and second plug portions, the third plug portion having a smaller cross-sectional area than the first or second plug portions, and forming, when inserted in the bore, a fluid passageway between an exterior surface of the third plug portion and an interior surface of the bore,
first and second axially spaced-apart seals forming respective seals between the exterior surface of the first plug portion and the interior surface of the bore;
a third seal forming a seal between the exterior surface of the second plug portion and the interior surface of the bore, wherein:
the first and second ports are axially offset such that:
when the plug is in a first position, the first port is located at a position between the first and second seals, and the second port is located a position between the second and third seals; but
when the plug is in a second position, the first and second ports are located at a position between the second and third seals; wherein the valve further comprises:
a rack operatively connected to the plug, and
a pinion gear arranged to mesh with the rack, whereby
rotation of the pinion gear causes the plug to move between the first and second positions.

2. The valve of claim 1, wherein when the plug is in the second position, the fluid passageway interconnects the first and second ports.

3. The valve of claim 1, wherein the first port comprises an inlet and the second port comprises an outlet.

4. The valve of claim 1, wherein the first port comprises an outlet and the second port comprises an inlet.

5. The valve of claim 1, wherein:
the main body comprises a third port in fluid communication with the bore;
the second plug portion comprises a fourth seal forming a seal between the exterior surface of the second plug portion and the interior surface of the bore; and
the first, second and third ports are axially offset relative to one another such that:
when the plug is in the first position, the first port is located at a position between the first and second seals, and the second and third ports are located at positions between the second and third seals; but
when the plug is in the second position, the first and second ports are located at a position between the second and third seals, and the third port is located at a position between the third and fourth seals.

6. The valve of claim 5, wherein when the plug is in the first position, the fluid passageway interconnects the second and third ports, but when the valve in the second position, the fluid passageway interconnects the first and second ports.

7. The valve of claim 5, wherein the third port comprises an inlet or an outlet.

8. The valve of any claim 1, wherein rotation of the pinion gear through substantially ninety degrees causes the plug to move between the first and second positions.

9. The valve of claim 1, wherein the plug comprises a respective radial groove for receiving each of the said seals, which are O-ring seals.

10. The valve of claim 9, wherein the planes of the respective radial grooves are arranged perpendicularly to the axis of the bore.

11. The valve of claim 1, wherein any two or more of the ports are radially offset relative to one another by substantially ninety degrees.

12. The valve of claim 1, wherein the bore is substantially cylindrical, and wherein third plug portion is substantially cylindrical such that the fluid passageway is substantially annular-prism-shaped.

13. The valve of claim 1, further comprising means for indicating the position of the plug.

14. The valve of claim 13, wherein the means for indicating comprises an axial extension of the plug arranged to protrude through an aperture of the main body when the plug is in one of the first and second positions, and to retract within the main body when the plug is in the other of the first and second positons.

15. The valve of claim 13, wherein the means for indicating comprises a magnetic reed switch disposed within the plug, and a magnet disposed with in the main body, a circuit and an indicator light, wherein the circuit is adapted to illuminate the indicator light when the reed switch is in a first position relative to the magnet, and to extinguish the indicator light when the reed switch is in a second position relative to the magnet.

16. The valve of claim 15, wherein the circuit comprises a battery, and wherein the indicator light comprises an LED.

17. The valve of claim 16, wherein the LED comprises a high intensity, wide-angle, red-coloured LED.

18. The valve of claim 13, wherein the circuit is adapted to illuminate the indicator light intermittently when the reed switch is in the first position relative to the magnet.

19. The valve of claim 13, wherein the means for indicating is waterproof.

20. A SCUBA diving diverter valve according to claim 7, when dependent on claim 3, wherein the second port comprises an outlet operatively connectable directly to a regulator, wherein the first port comprises an inlet operatively connectable to a primary air hose that interconnects, in use, the first port to a primary breathable air cylinder, and wherein the third port comprises an inlet operatively connectable to a reserve air hose that interconnects, in use, the third port to a reserve breathable air cylinder.
